(19) United States
(12) Patent Application Publication
(10) Pub. No.: US 2012/0037703 A1
(43) Pub. Date: Feb. 16, 2012

(54) OPTICAL DEVICE, OPTICAL INFORMATION READING DEVICE AND LIGHT SOURCE UNIT MOUNTING METHOD

(75) Inventor: Masayoshi Yamanouchi, Saitama Pref. (JP)

(73) Assignee: Optoelectronics Co., Ltd., Saitama Pref (JP)

(21) Appl. No.: 13/018,775

(22) Filed: Feb. 1, 2011

(30) Foreign Application Priority Data
Aug. 13, 2010 (JP) 2010-181432

(51) Int. Cl. G06K 7/14; B23P 11/00; H01S 3/00

(52) U.S. Cl. 235/454; 250/492.1; 29/428

(57) ABSTRACT

When an optical module is manufactured, a module package is used in which a collimating lens is attached, and in which a pedestal is installed to arrange the laser light source unit so that the laser beam is outputted substantially parallel to the optical path passing through the optical axis of the collimating lens. First, the laser light source unit is attached to the pedestal using clips so that it can move only in the direction along the optical path. The laser light source unit is then moved in the direction along the optical path, and its position is adjusted so that the laser beam is parallel light from the collimating lens. Afterwards, the laser light source is secured to the pedestal using an adhesive so that it cannot move in the direction along the optical path.

### BACKGROUND OF THE INVENTION

The present invention relates to an optical device equipped with an illuminator or irradiator for illuminating an object with light, an optical information reading device for reading information represented by in a sequence of code symbols in a module whose optical reflectivity differs from its surroundings, and a light source unit mounting method for mounting the light source unit in the optical device.

Code symbols such as barcodes and two-dimensional codes are images constituted of modules of black bars (or simply bars) and white bars (or spaces). As is well known, product information is expressed in these code symbols. These code symbols are printed on or affixed to products, and the code symbols are read by an optical information reading device. Use of these code symbols is typified by point-of-sale (POS) systems used in supermarkets and retail outlets. However, they are also used in distribution, postage, event management, medicine and chemical analysis.

Optical information reading devices can be divided, broadly speaking, into laser code scanners using lasers and area sensor scanners using a camera with a charge-coupled device (CCD) or complementary metal oxide semiconductor (CMOS). Compared to area sensor scanners, laser code scanners have a longer history, greater accumulation of technologies and better reliability.

Laser code scanners include compact optical scanning modules in which the object to be read is scanned with a light beam (laser beam) using a semiconductor laser element as the light source, and information is decoded from the reflected light. As is well known, these optical scanning modules can use the laser beam deflecting method, the multiple-surface mirror (polygon mirror) rotating method or the vibrating mirror method in the scanning process.

For example, Publication of Unexamined Japanese Patent Application No. 2009-259058 (JP 2009-259058 A) describes a barcode reading device in which light is emitted from a light-emitting element such as a semiconductor laser, and reflected towards the object to be read using a surface of a polygon mirror. Japanese Patent Gazette No. 4,331,597 (JP 4,331,597 B2) describes an optical information reading device in which a laser beam emitted from a light-emitting unit is reflected towards the object to be read by a vibrating mirror which is vibrated using the seesaw method. In order to direct multiple light beams at the object to be read, the former device uses a polygon mirror with multiple reflective surfaces and the latter device uses a single-surface mirror that is vibrated.

Multiple light beams reaching the object to be read have an effect on precision when the code symbols are decoded, so multiple beams reaching the object to be read enable better decoding.

While this leads to better decoding precision, it is difficult to make smaller and thinner optical scanning modules for optical information reading devices that scan with a laser beam and detect reflected light. In recent years, optical scanning modules have been built into information reading devices such as handheld scanners. Optical scanning modules are also being built into multi-function electronic devices such as handheld information terminals and smart phones.

An optical scanning module using the technology disclosed in JP 4,331,597 B2 was the world's smallest known optical scanning module at the time of the disclosure. However, an even more compact module is desired. The problem with making a more compact module resides in the optical performance of the module. In other words, unless a compact module is devised with a configuration that has sufficient light beam intensity, the intensity of the light beam scanning the object to be read will be weak and the decoding precision will be poor.

In light of this situation, the purpose of the present invention is to downsize an optical device for scanning an object to be read with a light beam and detecting the reflected light, and a compact optical information reading device using a module with these functions.

In order to achieve this purpose, one embodiment in accordance with the present invention is an optical device equipped with an irradiator for irradiating an object with light, wherein the irradiator is equipped with a light source unit with a laser light source unit for outputting a laser beam and a collimating lens allowing the laser beam from the laser light source unit to pass through. The light source unit is equipped with a pedestal for arranging the laser light source unit so that the laser beam is outputted in the direction along the optical path passing through the optical axis of the collimating lens, and wherein the light source unit is secured by a first securing means to the pedestal so as to move only in the direction along the optical axis. A second securing means different from the first securing means secures the light source unit to the pedestal so as not to move in the direction along the optical axis. In this optical device, the pedestal can have a groove in the direction along the optical path, at least a portion of the optical unit can be inserted into the groove in the pedestal, and movement in directions other than the direction of the groove can be restricted.

In this optical device, a pair of protrusions can be formed on the light source unit and the pedestal, the protrusions can have a substantially constant width in the direction along the optical axis in the positions where the protrusions on the light source unit side and the protrusions on the pedestal side come into planar contact with each other when the light source unit is arranged on the pedestal. The first securing means can be elastic clips securing the protrusions on the light source unit side and the protrusions on the pedestal side while in contact with each other. Also, an exterior of the optical device can be equipped with a gap for inserting in the direction perpendicular to the optical path the clips securing the protrusions on the light source unit side and the protrusions on the pedestal side.

In this optical device, the irradiator can be a means for irradiating an object with a laser beam outputted from a laser light source unit via a collimating lens and an aperture with a slit-shaped opening. The collimating lens can be arranged in front of the aperture along the optical axis of the laser beam and have the same shape as the opening in the aperture, and the laser beam passing through the collimating lens can have a size greater than the opening so as to reach the aperture. Also, the collimating lens arranged in front of the aperture can have the power of a cylindrical lens on one side and the power of a collimating lens on the other side, and the lens can form an oval-shaped beam spot with the laser beam outputted from the laser light source unit.

In this optical device, the irradiator and a vibrating mirror for deflecting the laser beam outputted from the laser light source unit in the irradiator and scanning an object can be installed exteriorly, an opening can be formed in one side of the exterior, and the rotational axis of the vibrating mirror and the bearing for securing the vibrating mirror rotatably to the rotational axis can be arranged so as to pass through the opening. Also, a cover can be installed on one surface of the exterior to cover the rotational axis and bearing passing through the opening. In addition, the one side of the exterior can be a circuit board, and the circuit board can be secured by a securing tool to a case constituting the other side of the exterior. Another embodiment of the present invention is an optical information reading device equipped with any one of the optical devices described above for reading information represented by in a sequence of code symbols in a module whose optical reflectivity differs from its surroundings.

A further embodiment of the present invention is a light source unit mounting method for mounting a light source unit equipped with a laser light source for outputting a laser beam as the light source in an irradiator to the case of an optical device when an optical device equipped with an irradiator for irradiating an object with light is manufactured. The light source unit mounting method comprises in successive order a first step for preparing the case of the optical device equipped with a collimating lens and a pedestal for arranging the laser light source in the light source unit so that the laser beam is outputted substantially parallel to the optical path passing through the optical axis of the collimating lens, a second step for securing the light source unit to the pedestal using a first securing means so as to move only in the direction along the optical path, a third step for moving the light source unit in the direction along the optical axis and adjusting the position so that the laser beam outputted from the laser light source is converted to parallel light by the collimating lens, and a fourth step for securing the light source unit to the pedestal using a second securing means different from the first securing means so as not to move in the direction along the optical axis. In this light source unit mounting method, the pedestal can have a groove in the direction along the optical path, and the second step can include a step in which at least a portion of the light source unit is inserted into the groove in the pedestal. Also, a pair of protrusions can be formed on the light source unit and the pedestal, the protrusions can have a substantially constant width in the direction along the optical axis in the positions where the protrusions on the light source unit side and the protrusions on the pedestal side come into planar contact with each other when the light source unit is arranged on the pedestal, and elastic clips can secure the protrusions on the light source unit side and the protrusions on the pedestal side while in contact with each other in the second step.

### BRIEF DESCRIPTION OF THE DRAWINGS

The foregoing brief description and further objects, features and advantages of the present invention will be understood more completely from the following detailed description of presently preferred, but nonetheless illustrative, embodiments in accordance with the present invention, with reference being had to the accompanying drawings, in which:

FIG. 1 is a perspective view of the optical scanning module in an embodiment of the optical device of the present invention;

FIG. 2 is a front view looking in the direction of arrow A in FIG. 1;

FIG. 3 is a cross-sectional view along line 3-3 in FIG. 2 and looking in the direction of the arrows;

FIG. 4 is a perspective view of the light detector in the optical scanning module shown in FIG. 1;

FIG. 5 is a schematic diagram showing the arrangement of the light detector in the optical scanning module;

FIG. 6 is a diagram showing the arrangement of a known surface-mounted light detector;

FIG. 7 is a perspective view of the laser light source unit in the optical scanning module shown in FIG. 1;

FIGS. 8A-8D are a sequence of diagrams used to explain the process for mounting the laser light source unit in the module package using clips;

FIG. 9 is a top view of the laser light source unit mounted on the pedestal;

FIGS. 10A and 10B are a sequence of diagrams used to explain the process for mounting the circuit board to the module package with the laser light source unit;

FIG. 11 is a schematic diagram showing the cross-section of the portion of the optical scanning module in FIG. 1 extending from the coil to the support shaft and vibrating mirror holder;

FIG. 12 is a cross-section of the comparative example corresponding to FIG. 11;

FIG. 13A and 13B are diagrams used to explain the power of the lens in the optical scanning module shown in FIG. 1;

FIG. 14 is a diagram showing the shape of the spot formed by a laser beam passing through this lens;

FIG. 15 is a diagram showing the shape of this lens;

FIGS. 16A and 16B are diagrams used to explain the power of the lens in the comparative example corresponding to FIG. 13A and 13B, respectively;

FIG. 17 is a diagram used to explain the manufacturing method for a lens with the shape shown in FIG. 15; and

FIG. 18 is a block diagram showing the configuration of the code scanner in an embodiment of the optical information reading device of the present invention.

### DETAILED DESCRIPTION OF THE PREFERRED EMBODIMENT

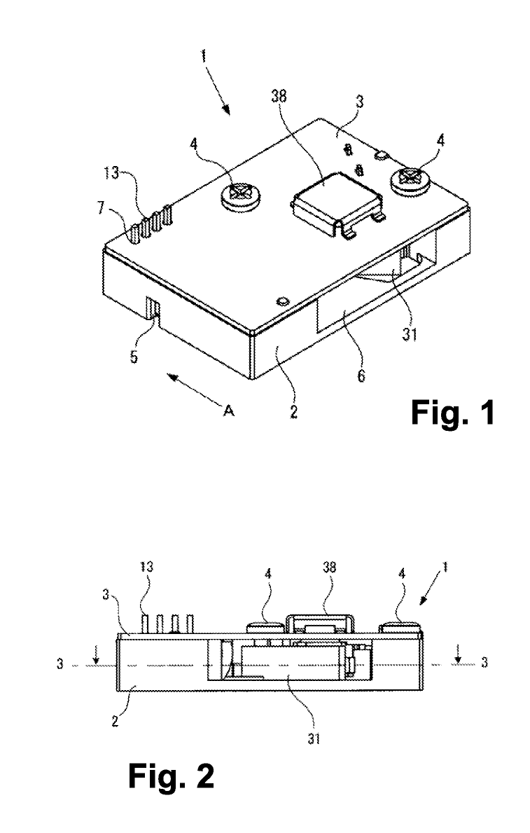

### Embodiment of the Optical Device: FIG. 1 Through FIG. 16B.

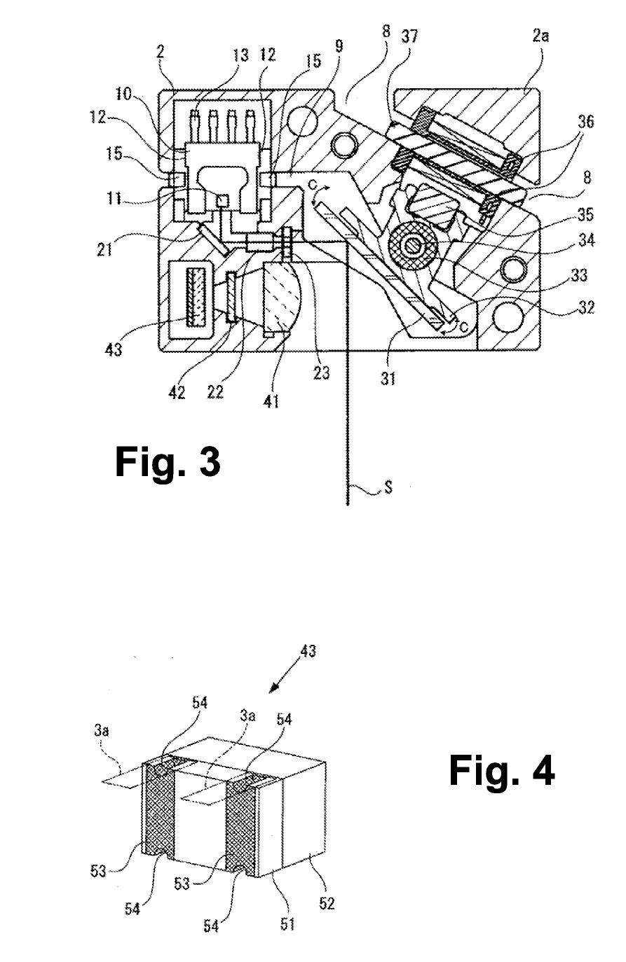

First, the optical scanning module in an embodiment of an optical device equipped with a light detector of the present invention will be explained. FIG. 1 is a perspective view of the optical scanning module, FIG. 2 is a front view looking in the direction of arrow A in FIG. 1, and FIG. 3 is a cross-sectional view along line 3-3 and looking in the direction of arrows in FIG. 2, in which the cross-hatching for portions other than the module case 2 is omitted.

In this optical scanning module 1, the exterior, as shown in FIG. 1 and FIG. 2, is constituted of a module case 2 and a circuit board 3 secured to each other by two screws 4, 4. The module case 2 is molded from a zinc alloy such as ZDC2 using the die-casting method, and the overall external dimensions are 14 mm×20.4 mm×3.4mm (D×W×H). In place of the zinc alloy, aluminum, an aluminum alloy or a magnesium alloy can be used. This component is molded from metal in order to obtain sufficient precision and strength and in order to obtain the shielding effect for the LSI described below. The component can also be molded with a resin such as a reinforcing plastic when separately considering the shielding effect.

In the module case 2 are installed slits 5 for inserting the clips 15 used to secure the laser light source unit 10 to the module case 2 as described below, and an opening 6 for the scanning laser beam to exit and for the reflected light to be detected to enter. In FIG. 3, the portion of the module case 2 denoted by 2a appears as a separate component. This component is connected to the other component by the portion above line 3-3 in FIG. 2.

In the circuit board 3 are formed through-holes 7 for insertion of the terminals 13 on the laser light source unit 10, and a through-hole for insertion of the support shaft 34 and bearing 33 for the vibrating mirror 31 described below. The latter through-hole is covered by the cover 38 in FIG. 1 and so is not shown in the figure. Various components are installed on the insides of the module case 2 and the circuit board 3 as shown in FIG. 3. The following is an explanation with reference to FIG. 3. The major components shown in FIG. 3 will be explained below in greater detail. Accordingly, these components will not be explained with reference to FIG. 3.

First, the module case 2 is equipped with the laser light source unit 10 serving as the light source in the irradiator for irradiating the object with a laser beam. The laser light source unit 10 is a thin package laser in which the semiconductor laser 11 serving as the laser light source for outputting the laser beam is installed near one end. A pair of flange-shaped protrusions 12, 12 is provided on the side to be pressed against the corresponding protrusions on the pedestal formed on the module case 2 by the clips 15, 15. The protrusions on the end of the pedestal are not shown in FIG. 3. In the laser light source unit 10, four terminals 13 are installed on the end opposite the semiconductor laser 11. This is exposed to the outside of the optical scanning module 1 via a through-hole 7 installed in the circuit board 3. Drive signals for driving the laser light source unit 10 can be inputted from the outside via terminals 13.

In the module case 2 are also installed a mirror 21, lens 22 and an aperture 23 serving as the optical elements constituting the light projecting optics for projecting the laser emitted from the semiconductor laser 11 installed in the laser light source unit 10 as a beam forming an oval-shaped beam spot.

The mirror 21 is a fixed mirror used to change the direction of the optical path of the laser beam. The lens 22 is a lens with the power of a collimating lens and the power of a cylindrical lens only in one of the X direction and Y direction perpendicular to each other. The radial laser beam outputted from the semiconductor laser 11 passes through this lens 22 and is converted into parallel light with a round spot by the power of the collimating lens and into a beam with an oval-shaped spot by the power of the cylindrical lens. The aperture 23 cuts off the ends of the beam passing through the lens 22 in order to narrow the beam to the desired diameter.

The laser beam passed through the aperture 23 is reflected by a vibrating mirror 31 swinging like a seesaw as indicated by arrow C, and directed out from the opening 6 along the optical path indicated by S. In this way, the object scanned by the laser beam can be scanned reciprocatingly.

The components in the module case 2 used to vibrate the metal, resin or glass vibrating mirror 31 include a vibrating mirror holder 32 made of resin with the vibrating mirror 31 attached to the front face, a support shaft 34, and a coil 36. The vibrating mirror holder 32 is supported rotatably on the support shaft 34 serving as the rotational axis by a resin bearing 33, and a moving magnet (permanent magnet) 35 is secured to the end opposite the end to which the vibrating mirror 31 has been attached. A yoke 37 is passed through the coil 36 in the direction perpendicular to the winding direction. In the cross-section of FIG. 3, the coil 36 and the yoke 37 have been cut away near the center of the yoke 37.

When the moving magnet 35 and the yoke 37 are in an inactive state (the coil 36 is not being electrified), they are generally parallel. In this state, the cross-sectional area of the yoke 37 in the direction perpendicular to the parallel direction is smaller than the cross-sectional area in the parallel direction. The terminals (not shown) of the coil 36 are connected to the circuit board 3, and control signals are supplied from the circuit board 3.

The yoke 37 is secured by pushing it into a pair of slits 8, 8 formed in the side wall and inner wall of the module case 2 via the insulating material doubling as the bobbin for the coil 36. The arrangement of the yoke 37 and the arrangement of the coil 36 are adjusted with respect to the magnetic force and then secured in that position.

The moving magnet 35 in the vibrating mirror holder 32 is arranged so as to be separated slightly from the coil 36. The support shaft 34 is covered by a bearing 33 serving as a sliding bearing, and is held loosely by a slider (not shown) whose upper and lower surfaces in the axial direction are fitted to the support shaft 34. In this way, the vibrating mirror holder 32 is movingly supported in the axial direction and within a predetermined range by the support shaft 34.

The slider is a resin washer that allows for non-contact and prevents interference so that the vibrating mirror holder 32 remains in a floating state. When different polarity voltage is applied alternatingly to the coil 36 in this state, the action of the electromagnetic induction between the coil 36 and the moving magnet 35 causes the vibrating mirror 31 to seesaw centered on the support shaft 34.

In the module case 2, reflected light from the scanned object enters via the opening 6. The incoming light is reflected by the vibrating mirror 31 and directed towards the light-receiving lens 41 with condensing power. Because the light returns at the same angle with respect to the light-receiving lens 41 irrespective of the vibration phase of the vibrating mirror 31 (scanning at whatever angle), the vibration of the vibrating mirror 31 causes no problems.

A filter 42 selectively permeable to light with the wavelength of the laser beam outputted from the laser light source unit 10 is installed where the reflected light has passed through the light-receiving lens 41, and the incident light is cut off in the range outside of the reflected light of the scanning beam. For example, if the wavelength of the laser beam is 650 nm (nanometers), the filter 42 is selectively permeable to a beam with a wavelength of 650 nm. If an infrared laser is used, an infrared (IR) filter is used that is selectively permeable to infrared light with this wavelength.

A light detector 43 equipped with a photodiode is mounted on the circuit board 3 near the focal point of the light-receiving lens 41 after the reflected light has passed through the filter 42. The light-receiving lens 41 and the filter 42 are fixed to the module case 2, but the light detector 43 is mounted on the circuit board 3 in FIG. 1 and FIG. 2.

The light detector 43 outputs electric signals from electrodes installed on the surface opposite the light-receiving surface with the photodiode based on the light intensity registered by the photodiode. For example, when code symbols arranged in alternating black bars and white spaces are scanned by laser beam and the reflected light from the from the symbols is received by the light detector 43, low-level electric signals are obtained as output from the light detector 43 on the timing of the reflected light received from the low-reflectivity black bars and high-level electric signals are obtained as output from the same detector on the timing of the reflected light received from the high-reflectivity white spaces. When the electric signals outputted from the light detector 43 are extracted and interpreted by the circuit board 3, the bar arrangement can be estimated and the information signified by the code symbols can be read.

The following four sections of this document describe distinctive portions of the optical scanning module 1 explained above.
(1) The Configuration of Light Detector 43 and the Mounting Configuration to Circuit Board 3.
(2) The Process and Configuration for Mounting the Laser Light Source Unit 10 to the Module Package 2.
(3) The Arrangement of the Bearing 33 and Support Shaft 34 for the Vibrating Mirror Holder 32.
(4) The Performance and Configuration of the Lens 22.

These sections will now be presented in successive order with reference to the figures.

(1) Configuration of Light Detector 43 and Mounting Configuration to Circuit Board 3. (FIG. 4 through FIG. 6)

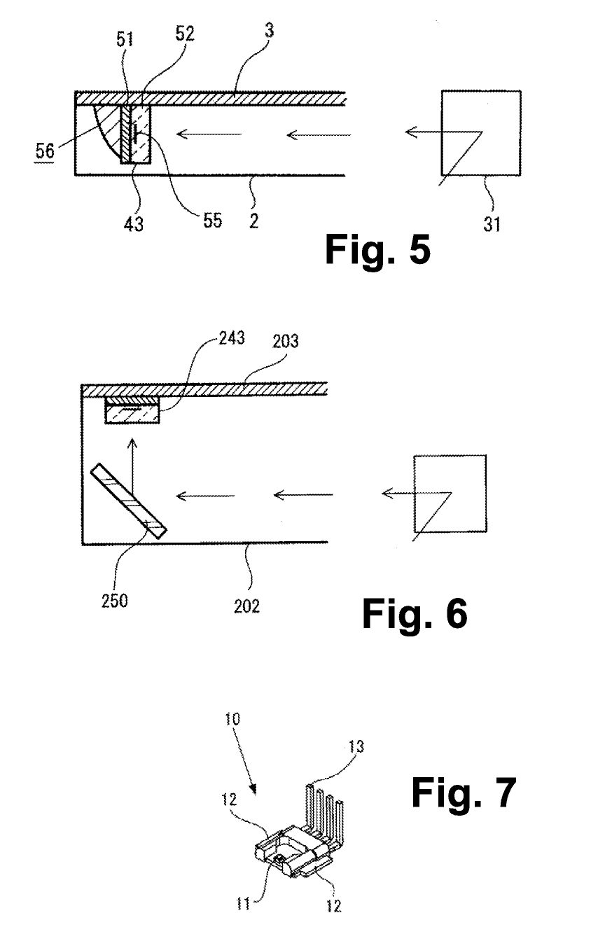

First, the configuration of the light detector 43 and the mounting configuration to the circuit board 3 will be explained. FIG. 4 is a perspective view of the light detector 43. FIG. 5 is a schematic diagram showing the arrangement of the light detector 43 in the optical scanning module 1. As shown in FIG. 4, the light detector 43 has a photodiode (PD) 55 shown in FIG. 5 installed as the light-receiving element on the substrate 51. This is covered by a transparent resin covering material 52 in order to protect the PD 55. In other words, the PD 55 is installed on the surface of the substrate 51 covered with the coating material 52.

A pair of flat, output electrodes 53, 53 are installed on the side of the substrate 51 opposite the side on which the PD 55 is installed in order to output electric signals corresponding to the intensity of the light received by the PD 55. The PD 55 is connected to these output electrodes 53, 53 using a configuration common in the art, so depiction in the figures and further explanation have been omitted here. Notches 54 are formed in the surface of substrate 51 so as to be adjacent to but on a surface different from the surface on which the output electrodes 53 are formed. Notches 54 are also on a surface different from the surface on which PD 55 is installed, and they are positioned so as to come into contact with the output electrodes 53. Electrodes connected to the output electrodes 53 are installed inside the notches 54.

In FIG. 4, the electrodes installed inside the notches 54 are denoted with the same cross-hatching as the output electrodes 53. However, it is not essential that the electrodes be installed inside the notches 54 in the same step as the output electrodes 53, and it is not necessary to use the same material. Also, the electrodes do not have to be installed over the entire inside surface of the notches 54. However, if there are multiple output electrodes 53, the notches 54 and their internal electrodes are installed so that they connect to a corresponding one of the output electrodes 53 and so that different output electrodes 53 are not connected to each other. Preferably, the notches 54 are formed in the substrate 51 so that the surface with the PD 55 installed is not reached. This could have an adverse effect on covering the side with the covering material 52.

When the light detector 43 is mounted on the circuit board 3, the output electrodes 53 and the notches 54 are aligned with the pad electrodes 3a on the circuit board 3 serving as the connection electrodes to be connected to the output electrodes 53 as shown in FIG. 4. The output electrodes 53 are then connected to the pad electrodes 3a using solder 56. By filling the notches 54 with solder 56 at this time, the output electrodes 53 and the pad electrodes 3a can be connected readily and reliably via the electrodes installed inside the notches 54.

In the example shown in FIG. 5, the solder 56 covers not only the notches 54 but also the output electrodes 53. This is intended to increase the connection area between the output electrodes 53 and the pad electrodes 3a and to increase the adhesive strength between the light detector 43 and the circuit board 3. However, a connection can be established simply by filling the interior of the notches 54 with solder if there is a desire to reduce the amount of solder used.

The use of this light detector 43 and mounting configuration to the circuit board 3 allows a compact light detector to be readily mounted with the light- receiving surface perpendicular to the circuit board 3. Thus, as shown in FIG. 5, incident light from the outside is reflected by the vibrating mirror 31 which is the first optical component for light directed towards the PD 55 in the light detector 43. The reflected light can then be directed towards the light-receiving surface of the light detector 43 along an optical path parallel to the surface of the circuit board 3 with the pad electrodes 3a installed (via the light-receiving lens 41 and the filter 42 omitted from FIG. 5).

A compact and inexpensive light detector 43 can be mass produced if the light detector has the output electrodes 53 on the back surface of the substrate 52, multiple PDs 55 are installed on a substrate 51 and covered by a covering material 52, and the individual light detectors 43 are cut away after the output electrodes 53 have been installed. The notches 54 can be created before the substrate is cut apart, and the inside can be plated with an electrode material.

A light detector with the output electrodes 53 installed on the back surface of the substrate 51 is well known in the art surface mounted device. However, this type of device presupposes the mounting of output electrodes on a circuit board opposite the connection electrodes on the circuit board. FIG. 6 shows this arrangement in a surface mounted light detector 243 of the related art. In a light detector 243 of the related art, as shown in FIG. 6, the light-receiving portion has to be parallel to the surface of the circuit board 203 with the connection electrodes. When the optical path of the reflected light is parallel to this surface, a reflecting mirror 250 has to be installed to change the optical path so that the reflected light is directed towards the light-receiving portion.

As a result, the number of components is increased and the optical path has to be arranged so that it has a certain path length directed perpendicular to the circuit board 203. It also makes it difficult to reduce the thickness of an optical scanning module including a module case 202 (the size perpendicular to the circuit board). Some light detectors are known to have the light-receiving portion arranged perpendicular to the circuit board, but the electrodes are formed by lead wires. This causes problems with the number of components and manufacturing steps, and makes it difficult to obtain a compact light detector compared to light detector 243.

The structure in FIG. 4 and FIG. 5 makes it easy to reduce the size of the light detector 43 itself. The incident light can be directed at the light-receiving surface of the light detector 43 via an optical path that is parallel to the surface of the circuit board 3 with the pad electrodes 3a installed. As a result, a thinner optical scanning module 1 can be obtained. Thus, this configuration can be said to be extremely useful in the miniaturization of the optical scan module 1.

In the example shown in FIG. 4, the light detector 43 can be mounted on the circuit board 3 without any concern regarding top and bottom, because notches 54 are installed in the two surfaces making contact with the output electrode. However, the notches 54 only have to be installed in one of these surfaces. In the example shown in FIG. 4, the light detector 43 is rectangular. However, the present invention is not limited to this. If the surface in which the notches 54 are formed and the surface on which the PD 55 is installed (the light-receiving surface) are almost vertical, the light-receiving surface and the surface of the circuit board in which the connection electrodes are installed can be arranged almost vertically when the light detector 43 is mounted on the circuit board 3, and the effect described above can be obtained.

(2) Mounting of Laser Light Source Unit 10 to Module Package 2 (FIG. 7 through FIG. 10B)

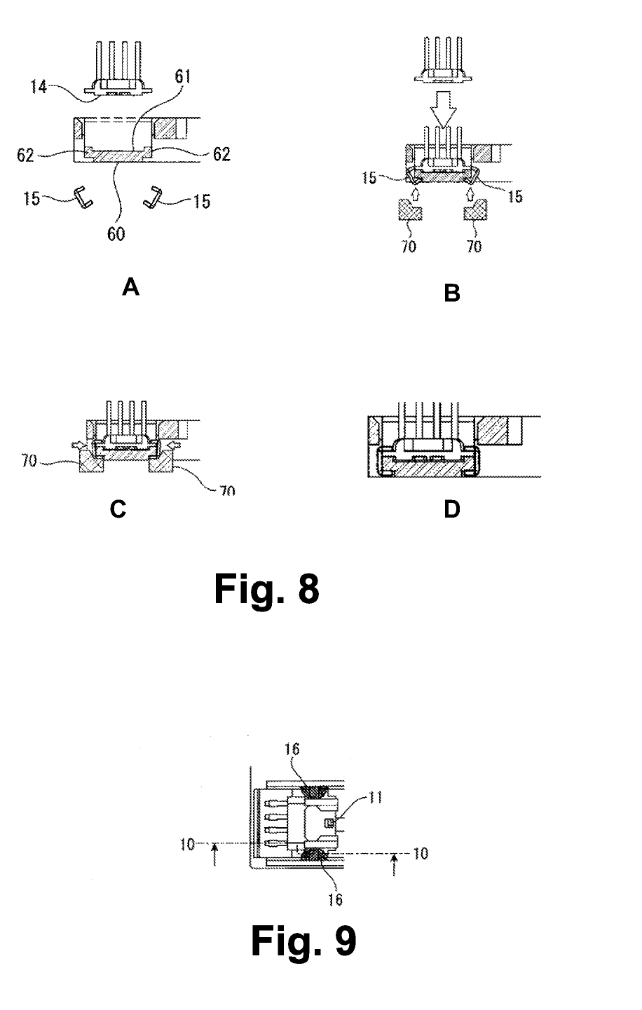

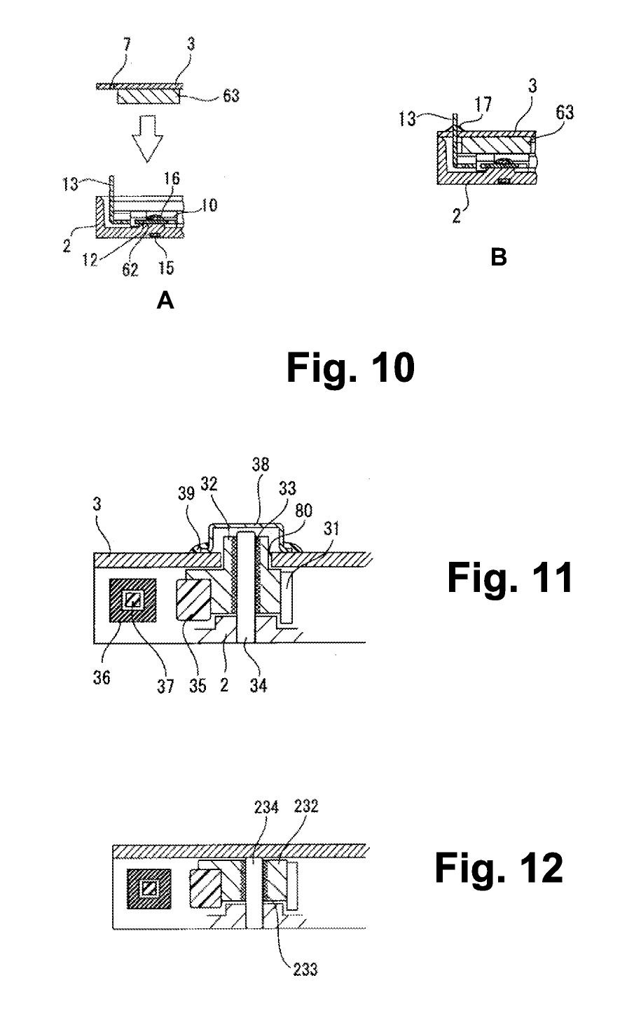

First, the process and structure for attaching the laser light source unit 10 to the module case 2 will be explained. FIG. 7 is a perspective view of the laser light source unit 10. FIG. 8A through FIG. 8D are diagrams used to explain the process for securing the laser light source unit 10 to the module case 2 using clips 15. FIG. 9 is a top view showing the laser light source unit 10 mounted on the pedestal 60. FIG. 10A and FIG. 10B are diagrams used to explain the process of mounting the circuit board 3 to a module case 2 to which the laser light source unit 10 has been attached. In FIG. 8A through FIG. 8D, the hatching indicating the cross-sectional surface of the laser light source unit 10 has been omitted.

As described in the explanation of FIG. 3 and shown in FIG. 7, the laser light source unit 10 is equipped with a semiconductor laser 11 near one end, a pair of flange-shaped protrusions 12, 12 on the side surfaces, and four terminals 13 at the end opposite the semiconductor laser 11. The terminals 13 are bent in the optical scanning module 1 so as to penetrate the circuit board 3 and protrude upward. This saves the necessary space to the rear in which the laser light source unit 10 is mounted.

The section lines have been omitted from the figures, but FIG. 8A through FIG. 8D show the steps to secure the laser light source unit 10 to the module case 2 using clips 15, 15. This is viewed in cross-section from the bottom of FIG. 3 at the position of the connecting line near the center of the two clips 15, 15 in FIG. 3. Therefore, in FIG. 8A through FIG. 8D, the laser beam is outputted towards the front of the figure from the back of the figure, and this direction is the direction of the optical path of the beam deflected by the mirror 21 and passing though the optical axis of the lens 22.

As shown in FIG. 8A, a pedestal 60 is formed in the module case 2, and the laser light source unit 10 is arranged on top. A groove 61 is formed in the center of the pedestal 60 and a pair of protrusions 62, 62 is formed on both ends. When the laser light source unit 10 is arranged on the pedestal 60, the laser light source unit 10 is inserted into the module case 2 from above. As shown in FIG. 8B, the portion 14 (positioned opposite the circuit board 3) below the protrusion 12 on the laser light source unit 10 is fitted into the groove 61 in the pedestal 60. When the width of the groove at the position denoted by the number 14 is the substantially same width as groove 61, the laser light source unit 10 can be moved only in the direction parallel to the groove 61 in the pedestal 60. In other words, it can only be moved in the direction of the optical path of a beam passing through the optical axis of the lens 22.

When the laser light source unit 10 is arranged on top of the pedestal 60, the protrusions 12, 12 on the laser light source unit 10 and the protrusions 62, 62 on the pedestal 60 make contact with each other on a plane. In this state, the elastic clips 15, 15 serving as the first securing means are inserted from the left and right in FIG. 8B or from the direction perpendicular to the optical axis of a beam passing through the optical axis of the lens 22. Jigs 70, 70 are used to apply pressure from below and the side as shown in FIG. 8B and FIG. 8C so that, as shown in FIG. 8D, the protrusions 12, 12 on the laser light source unit 10 and the protrusions 62, 62 on the pedestal 60 are secured so as not to separate. During the securing step, there is no need to be concerted with the position of the laser light source unit 10 with respect to the direction of the optical path of a beam passing through the optical axis of the lens 22.

FIG. 9 is a top view showing the mounted position of the laser light source unit 10 in this state. The clip 15 on the left side in FIG. 8A through FIG. 8D can be inserted through the slit 5 installed in the side surface of the module case 2 and the clip 15 on the right side of the figures can be inserted from the gap 9 installed in the bottom surface of the module case 2 (see FIG. 3).

When the laser light source unit 10 has been secured to the pedestal 60 using the clips 15, the laser light source unit 10 does not move either left and right or up and down in FIG. 8D. However, there is no component to keep it from moving from the back of the figure towards the front or from the front of the figure towards the back. Therefore, by applying a force able to resist the frictional force of the clips 15, 15 on protrusions 12, 12 and 62, 62 the laser light source unit 10 can be moved on top of the pedestal 60 from the back of the figure towards the front or from the front of the figure towards the back. This allows the laser light source unit 10 to be moved in order to adjust the optical path from the semiconductor laser 11 to the lens 22, arrange the semiconductor laser 11 near the focal point of the lens 22, and obtain a beam spot from the lens 22 of the appropriate size.

If protrusions 12, 12 and protrusions 62, 62 have a constant width lengthwise in the direction of the optical path of a beam passing through the optical axis of the lens 22, the protrusions do not push the clips 15, 15 outward and away even when the laser light source unit 10 is slid over the pedestal 60, and the securing strength of the clips 15, 15 do not weakened due to width of the clipped protrusions becoming narrower.

If the laser light source unit 10 is mounted before the vibrating mirror 31 is installed in the module case 2, a focus adjusting mirror (not shown) can be inserted in the position of the vibrating mirror 31 to reflect the laser beam emitted via the lens 22 and aperture 23 towards the outside. A laser beam measuring device (not shown) can then be used to precisely measure the diameter of the laser beam and to properly position the moving laser light source unit 10. The laser adjusting mirror is removed once the adjustment has been made.

After making the adjustment, the clips 15, 15 are secured with the protrusions 12, 12 on the laser light source unit 10 and the protrusions 62, 62 on the pedestal 60 using an adhesive 16, 16, which is the second securing means. The laser light source unit 10 then cannot move even in the direction of the optical path of a beam passing through the optical axis of the lens 22 (the adhesive 16, 16 is omitted from FIG. 3).

After securing this with adhesive and attaching all of the necessary components including the vibrating mirror 31 to the module case 2, as shown in FIG. 10A and FIG. 10B, the circuit board 3 is attached to the module case 2 with the screws 4, 4 shown in FIG. 1 (FIG. 10A and FIG. 10B are cross-sectional views of the components from the position of line 10-10 in FIG. 9). At this time, the terminals 13 on the laser light source unit 10 are passed through the through-holes 7 in the circuit board 3. The terminal 13 are connected to the electrodes on the circuit board 3 (not shown in the figure) and embedded in the through-holes 7 using solder 17.

Due to manufacturing errors in the module case 2, there is some individual variation in the position of the laser light source unit 10 after position adjustment. Therefore, the diameter of the through-holes 7 should be somewhat larger than the cross-section of the terminals 13 so that the through-holes 7 can be passed over the terminals 13 even when the position of the laser light source unit 10 is somewhat off. By installing the analog LSI 63 used to convert the analog electric signals outputted by the light detector 43 into digital data to the circuit board 3 in the position immediately above the laser light source unit 10 mounted on the module case 2, space can be effectively utilized.

The configuration and method for attaching the laser light source unit 10 to the module case 2 explained above allows the laser light source unit 10, while secured to the pedestal 60 by clips 15, 15, to be moved toward a position near the lens 22 and also toward a position away from the lens 22. Therefore, unlike inserting the light-emitting unit into a lens barrel hole under pressure and aligning the position of the light source, as described in JP 4,331,597 B2, the adjustment can be made easily and precisely.

In other words, the light source, once pushed in close to the collimating lens, cannot be adjusted in the direction away from the lens, in the case of insertion under pressure. Therefore, the push in operation has to be performed very carefully so as not to overshoot the target point. In order to be safe, it has to be adjusted slightly in front of the target point. However, the configuration and steps described with reference to FIG. 7 through FIG. 10 allow the laser light source unit 10 to be adjusted easily away from the lens 22 when after being moved too close. The laser light source unit 10 can be adjusted without fear, and the unit can be repeatedly readjusted until the error is sufficiently small with respect to the target point.

Also, the configuration is not complicated, the overall size is compact, the components are inexpensive, and the manufacturing can be performed with precision. By forming a groove 61 in the pedestal 60 for inserting the laser light source unit 10, the laser light source unit 10 is easily kept from moving in directions other than the optical path passing through the optical axis of the lens 22, which do not require adjustment.

By providing protrusions 12, 12 and protrusions 62, 62, the clips 15, 15 can be installed easily using a tool as shown in FIG. 8A through FIG. 8D. As a result, the mounting step can be simplified. If the pedestal 60 is at the end of the module case 2, at least one gap is installed in the side surfaces of the module 2 for the clips 15 to be inserted. This causes fewer design limitations than having the gaps on the bottom surface.

(3) Arrangement of Bearing 33 and Support Shaft 34 for Vibrating Mirror Holder 32 (FIG. 11 and FIG. 12)

The following is an explanation of the arrangement of the bearing 33 and the support shaft 34 for the vibrating mirror holder 32. FIG. 11 is a schematic diagram showing the cross-section of the portion of the optical scanning module 1 extending from the coil 36 to the support shaft 34 and the vibrating mirror holder 32. FIG. 12 is a cross-section of the corresponding comparative example. However, in these figures, the cross-section of the module case is shown only near where the support shafts 34, 234 are mounted.

In the optical scanning module 1, as shown in FIG. 11, an opening 80 is formed in a position on the circuit board 3 corresponding to the support shaft 34, and one end of the support shaft 34 and the bearing 33 are passed through the opening 80. The other end of the support shaft 34 is attached to the module case 2. By using this configuration the size of the bearing 33 is not restricted to the thickness of the optical scanning module 1 (the size lengthwise with respect to the support shaft 34).

When the support shaft 234 and the bearing 223 are accommodated inside the optical scanning module, as in the comparative example shown in FIG. 12, the length of the bearing is not sufficient if the optical scanning module is too thin. There is a danger of misalignment of the bearing 233 and the support shaft 234, and the vibrating mirror holder 232 may rotate around the support shaft 234 with too much fluctuation (the rotational shaft of the vibrating mirror holder 232 will easily be misaligned with the support shaft 234).

However, there are no such problems with the configuration shown in FIG. 11. The vibrating mirror holder 32 can rotate stably around the support shaft 34 even when the optical scanning module 1 is thin. Thus, there are no restrictions on the size of the bearing and the optical scanning module 1 can be compact.

In the optical scanning module 1, as shown in FIG. 11, a cover 38 is installed on the circuit board 3 surface opposite that of the module case 2 in order to cover the support shaft 34 and the bearing 33 protruding from the opening 80. The cover 38 is secured on the circuit board 3 using solder 39. By installing a cover 38, the bearing portion of the vibrating mirror holder 32 can be protected from the infiltration of moisture and contaminants. If contaminants and moisture get into the bearing portion, the smooth rotation between the support shaft 34 and the bearing 33 is impeded. A cover 38 effectively prevents this. However, a cover 38 is not essential. This can be secured to the circuit board 3 using an adhesive or screws or it can be fitted into the circuit board 3 using some other appropriate securing means.

In the example shown in FIG. 11, an opening 80 is formed in the circuit board 3. However, an opening can also be formed in the abutting surface when the support shaft 34 extends to the side opposite the securing position. In this configuration, the circuit board at that surface is not essential. The bearing 33 passing through the opening 80 can have the desired thickness. In other words, it does not have to have the minimum thickness able to realize the bearing function. If the diameter of the opening 80 is nearly the same or slightly larger than the diameter of the bearing 33 passing through, a vibrating mirror holder 32 including a bearing 33 can be supported and kept from becoming misaligned by the opening 80, even if the rotational shaft of the vibrating mirror holder 32 is offset from the support shaft 34.

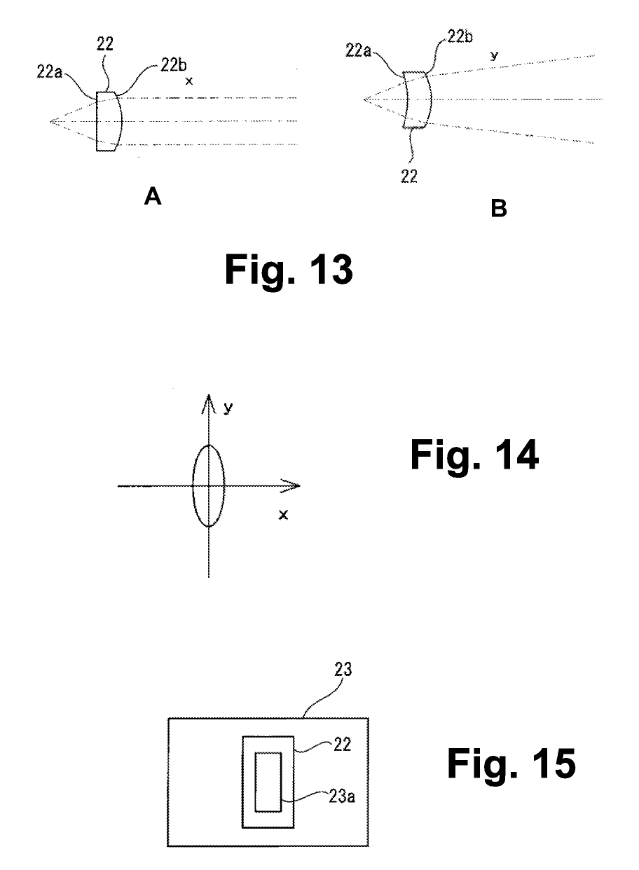

(4) Performance and Configuration of Lens 22 (FIG. 13 through FIG. 17)

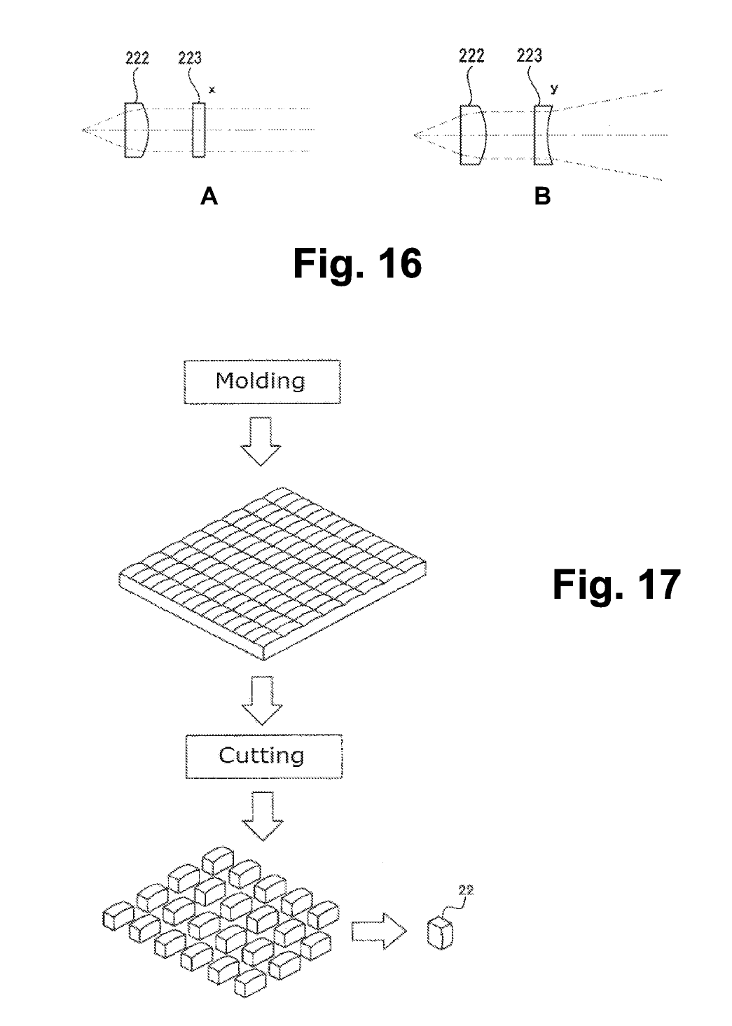

The following is an example of the performance and configuration of the lens 22. FIG. 13A and FIG. 13B are diagrams used to explain the powers of the lens 22. FIG. 14 is a diagram showing the shape of the spot formed by the laser beam passing through the lens 22. FIG. 15 is a diagram showing the shape of the lens 22. FIG. 16A and FIG. 16B are diagrams used to explain the powers of the lens in a comparative example. FIG. 17 is a diagram used to explain the manufacturing method for the lens 22.

If the optical scanning module 1 is used to read code symbols arranged in bar-type modules such as barcodes and two-dimensional barcodes, the spot of the laser beam used to scan the code symbols is preferably not round but oval-shaped with the long axis aligned lengthwise with respect to the code symbols. This can reduce the effects of bar contamination and friction. In the optical scanning module 1, as described above, an oval-shaped spot can be obtained from a lens 22 with the powers of both a collimating lens and a cylindrical lens only in one of the X direction and Y direction perpendicular to each other (both the X axis and the Y axis are perpendicular to the optical axis).

More specifically, FIG. 13A and FIG. 13B show the shape of the lens 22 in a cross-section on the plane including the optical axis and the X axis and in a cross-section on the plane including the optical axis and the Y axis, respectively. It is clear from the figures that the lens 22 has the power of a cylindrical lens on plane 22a as the cross-section in the X-axis direction is planar and the cross-section in the Y-axis direction is concave, and has the power of a collimating lens on plane 22b as the cross-section in the X-axis direction and the cross-section in the Y-axis direction are both convex.

A laser beam emitted from the semiconductor lens 11 of the laser light source unit 10 arranged in the appropriate location and passed through the lens 22, as shown in FIG. 14, forms a beam spot with an oval shape in which the Y-axis direction is the long axis. Afterwards, the unstable portions of the beam spot profile are cut off at the ends by the aperture 23. The beam is then reflected by the vibrating mirror 31 and emitted to the outside.

Here, the lens 22, as shown in FIG. 15, has a rectangular shape, which is the same shape as the opening 23a in the aperture 23. The size, however, is slightly larger than the opening 23a. A size slightly larger than the opening 23a allows the laser beam passing through the lens 22 to reach the aperture 23 with a size larger than the opening 23a. The size of lens 22 can be slightly smaller than the opening 23a in the Y-axis direction with the beam widening.

The ends of the laser beam passing through the lens 22 do not pass through the opening 23a but are instead cut off by the aperture 23. If the lens 22 is of a certain size, this does not adversely affect the quality of the scanning beam. During manufacture, the lens is first manufactured in a round shape. When a lens with a diameter conforming to the long sides of the aperture 23a is used, the width also has to be the same in the short-side direction in order to install the lens. However, this wastes space. Therefore, by using a lens 22 with the same shape as the opening 23a, wasted space can be eliminated. This makes a positive contribution to downsizing of the optical scanning module 1.

Rather than install a collimating lens 222 and a cylindrical lens 223, as in the comparative example shown in FIG. 16A and FIG. 16B, lens 22 combines the power of both in a single lens. This reduces the number of lenses required and saves space. In order to conform the shape of the lens 22 to the opening 23a, a rectangular lens can be manufactured. For example, as shown in FIG. 17, a lens plate molded into a shape combining multiple lenses can be cut to the size of an individual lens in order to manufacture a rectangular lens inexpensively.

Because the lens 22 has different powers in different directions, it has to be installed in the right direction inside the module case 2. It would be difficult to readily grasp the right direction if the lens were round. However, in the case of a rectangular lens, the X axis and the Y axis are cut to conform to the short side and the long side. This makes it easy to align in the right direction during installation. It also helps to reduce the number of manufacturing steps.

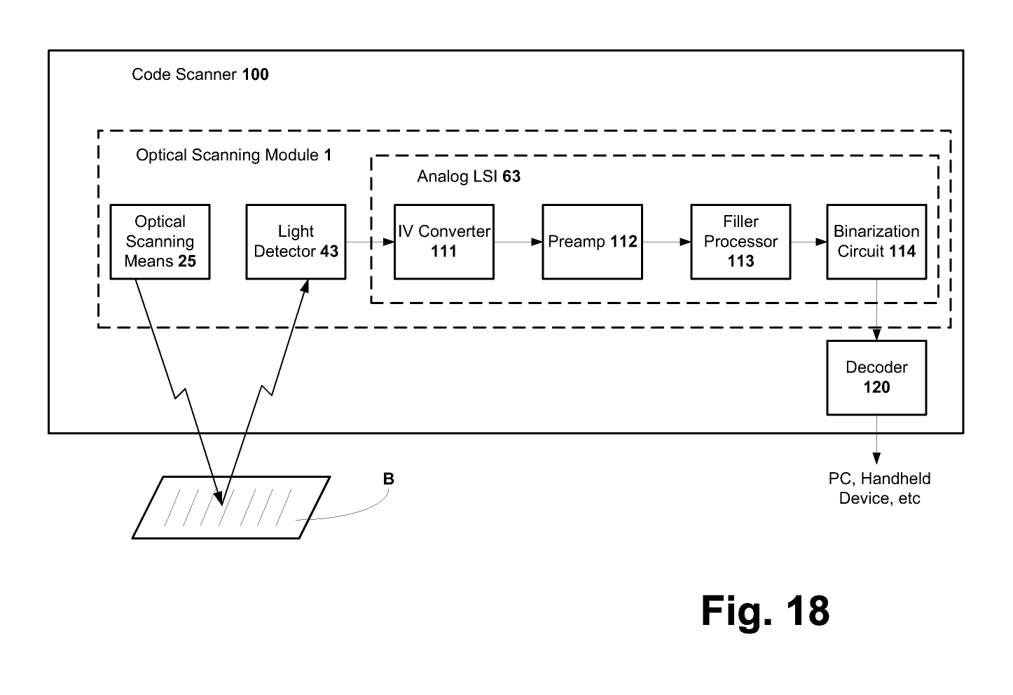

(5) Embodiment of the Optical Information Reading Device (FIG. 18)

The following is an explanation of an embodiment of an optical information reading device equipped with the optical scanning module 1 described above. FIG. 18 is a block diagram showing the configuration of the code scanner 100 that is the embodiment of the optical information reading device.

The code scanner 100 is a device that reads a barcode, which is code symbols constituted of modules of black bars and white bars whose optical reflectivity differs from their surroundings. As shown in FIG. 18, the code scanner 100 includes an optical scanning module 1 and a decoder 120. The optical scanning module 1 is the optical scanning module explained with reference to FIG. 1 through FIG. 17. The optical scanning device 25 is the optical system outputting a scanning beam from the laser light source unit 10 to the vibrating mirror 31. The light detector 43 is the light detector 43 shown in FIG. 3.

Electric signals corresponding to the strength of the reflected light obtained when the beam outputted from the optical scanning device 25 is reflected by the barcode B formed on the scanned object are outputted by the light detector 43 to the pad electrodes 3a on the circuit board 3 via the output electrodes 53. The signals are then inputted to the analog LSI 63 on the circuit board 3.

The analog LSI 63, as shown in FIG. 18, has an IV converter 111, a preamp 112, a filter processor 113 and a binarization circuit 114. This circuit processes the electric signals outputted by the light detector 43 and outputs a pulse sequence to the decoder for the barcode symbols. More specifically, the IV converter 111 converts the current signals outputted from the photodiode of the light detector 43 to voltage signals. Next, the preamp 112 amplifies the voltage signals converted by the IV converter 111. The IV converter 111 and the preamp 112 form an amplifier which converts the current signals to voltage signals and amplifies them.

Afterwards, noise is removed from the signals outputted from the preamp 112 by the filter processor 113, and the signals are inputted to the binarization circuit 114. The binarization circuit 114 includes a low-pass filter and a logic circuit, and outputs a pulse sequence indicating the positions of the white bars and the black bars. These correspond to the rows of bars constituting the barcode symbols. By inputting the pulse sequence to the decoder 120, information in the form of an arrangement of white bars and black bars is received and converted to information represented by the arrangement. The code scanner 100 can have a device for outputting the information obtained by the decoder 120 to an external information processing device such as a personal computer or a handheld terminal. The decoder 120 can also be located outside of the code scanner 100.

This ends the explanation of the embodiment, but the configuration of the devices and the type of code symbols to be read are by no means limited to the explanation in this embodiment. The optical information reading device in the present invention can be configured as a stationary device or as a portable device. The optical devices of the present invention such as the optical scanning module 1 can be used in optical information reading devices. However, nothing prevents them from being used in other devices. The same is true of the light detector and the light source unit mounting method.

The structures and variations described above can be applied individually or in combination where appropriate consistent with the scope of the present invention. The characteristics listed in (1) through (4) can be applied individually to sufficient effect. When only some of the characteristics are applied, the spots where the characteristics listed in (1) through (4) are not applied have the configurations described in the comparative examples and related art examples.

Use of the optical device and light source unit mounting method of the present invention allows a module used to scan an object with a laser beam and detect the reflected light to be made more compact. The same light detector can also be used to make the optical information reading device of the present invention more compact.

Although a preferred embodiment of the invention has been disclosed for illustrative purposes, those skilled in the art will appreciate that many additions, modifications and substitutions are possible without departing from the scope and spirit of the invention as defined by the accompanying claims.

### KEY TO THE FIGS.

1 . . . Optical Scanning Module
2 . . . Module Package
3 . . . Circuit Board
4 . . . Screw
5 . . . Slit
6 . . . Opening
7 . . . Through-Hole
8 . . . Slit
9 . . . Gap
10 . . . Laser Light source Unit
11 . . . Semiconductor Laser
12 . . . Protrusion
13 . . . Terminal
15 . . . Clip
21 . . . Mirror
22 . . . Lens
23 . . . Aperture
31 . . . Vibrating Mirror
32 . . . Vibrating Mirror Holder
33 . . . Bearing
34 . . . Support Shaft
35 . . . Moving Magnet
36 . . . Coil
37 . . . Yoke
38 . . . Cover
39 . . . Solder
41 . . . Light-Receiving Lens
42 . . . Filter
43 . . . Light Detector
51 . . . Substrate
52 . . . Coating Material
53 . . . Output Electrode
54 . . . Notch
55 . . . PD
60 . . . Pedestal
61 . . . Groove
62 . . . Protrusion
63 . . . Analog LSI
70 . . . Jig
80 . . . Opening
100 . . . Code Scanner

What is claimed:

1. In an optical device containing an irradiator for irradiating an object with light, the irradiator having a light source unit having a laser light source unit outputting a laser beam along an optical axis, the improvement comprising:
a pedestal on the light source unit supporting the laser light source unit so that the laser beam is outputted along the optical axis;
first securing means constructed to secure the laser light source unit to the pedestal so as to move only along the optical axis, and
second securing means constructed to secure the laser light source unit to the pedestal so as to be constrained against movement along the optical axis.

2. The optical device of claim 1 further comprising a collimating lens having an optical axis aligned in a light path containing the optical axis of the laser light source so that the laser beam passes through the collimating lens.

3. The optical device of claim 2 further comprising an aperture having a slit-shaped opening positioned in the light path emanating from the collimating lens, the lens having a shape conformed to the shape of the opening of the aperture, a light beam emanating from the collimating lens having a size greater than the opening in the aperture.

4. The optical device of claim 3 wherein the collimating lens has light entry and light exit faces and has the power of a cylindrical lens at one of the faces and the power of a collimating lens at the other of the faces, the lens forming an oval shaped beam spot with the light from the laser light source.

5. The optical device of claim 1, further comprising a groove in the pedestal extending generally parallel to the optical axis, at least a portion of the laser light source unit being received in the groove so that movement of the laser light source unit in a direction other than along the groove is restricted.

6. The optical device of claim 1 or 5, having a pair of protrusions formed on the light source unit so as to extend laterally of the optical axis, each protrusion having an engaging surface facing the pedestal, an engaging surfaces on the pedestal positioned to contact the engaging surfaces of the protrusions when the laser light source unit is on the pedestal, the first securing means being constructed to elastically retain the protrusion on the pedestal with their respective engaging surfaces in contact.

7. The optical device of claim 6 wherein the engaging surfaces are substantially planar and the protrusions have a substantially the same width at all positions therealong in the direction of the optical axis.

8. The optical device of claim 7, wherein the first securing means is a clip and a gap is provided in the optical device for inserting the clip from a direction lateral of a protrusion to urge that protrusion towards the pedestal.

9. The optical device of claim 1, further comprising a vibrating mirror disposed in the path of the laser beam so as to deflect the laser beam towards an object to scan the object, the vibrating mirror being installed on an exterior portion in which an opening is formed, a rotational axle of the vibrating mirror and a bearing for rotatably securing the vibrating mirror to the axle passing through the opening.

10. The optical device of claim 9, further comprising a cover on one surface of the exterior portion covering the rotational axle and bearing passing through the opening.

11. The optical device of claim 9 or 10, wherein one side of the exterior is a circuit board, the circuit board being secured to a case constituting the other side of the exterior portion.

12. An optical information reading device equipped with an optical device in accordance with any one of claims 1 through 9, for reading information displayed in a sequence of code symbols in a module having an optical reflectivity which differs from its surroundings.

13. A method for mounting a light source unit to a case of an optical device equipped with the light source unit when the optical device is manufactured, the light source unit including a laser light source outputting a laser beam along an optical axis, said method comprising the steps of:
providing in the case a pedestal constructed to receive the light source unit so that the optical axis is aligned along a predefined light path passing through a collimating lens;
using first securing means to secure the light source unit to the pedestal so as to move only along the optical axis;
adjusting the position of the light source unit along the optical axis so that the laser beam results in parallel light emanating from the collimating lens;
using second securing means to secure the light source unit to the pedestal so as to be restrained against movement along the laser optical axis.

14. The method of claim 13, wherein the pedestal has a groove directed substantially along the optical path, the step of using first securing means including placing at least a portion of the light source unit into the groove.

15. The method of claim 13 or claim 14 wherein the light source unit has a pair of protrusions extending laterally of the optical axis, each protrusion having an engaging surface facing the pedestal, the pedestal having engaging surfaces positioned to contact the engaging surfaces of the protrusions when the light source unit is on the pedestal, and the first securing means elastically retain the engaging surfaces of the protrusions in contact with the engaging surfaces on the pedestal during the adjusting step.

16. The method of claim 15 wherein the engaging surfaces are substantially planar and the protrusions have substantially the same width at all positions therealong in the direction of the optical axis.
